(19) United States
(12) Patent Application Publication
(10) Pub. No.: US 2018/0236578 A1
(43) Pub. Date: Aug. 23, 2018

(54) THREAD FORMER

(71) Applicant: WALTER AG, Tubingen (DE)

(72) Inventor: Daniel KUDERER, Zellam Harmersbach (DE)

(21) Appl. No.: 15/747,511

(22) PCT Filed: May 27, 2016
(86) PCT No.: PCT/EP2016/062046

§ 371 Date: Jan. 25, 2018

(30) Foreign Application Priority Data
Jul. 30, 2015 (EP) 15179157.1

(51) Int. Cl. B23G 5/06; B23G 5/00

(52) U.S. Cl. CPC B23G 5/06; B23G 2200/46; B23G 2240/12; B23G 5/005

(57) ABSTRACT

A thread former includes a shank and a forming section having a polygonal cross-section. A ridge or a plurality of ridges of the thread former extend along the circumference of the forming section that has at least two axially adjacent ridges and/or interruptions. In order to provide a thread former in which the wear is further reduced and the machining speed or the number of manufactured tapped holes can be further increased without increasing the wear or even with the reduction of wear, there is suggested that on axially adjacent ridge sections at least some of the interruptions are arranged at different angular positions.

### RELATED APPLICATION DATA

This application is a § 371 National Stage Application of PCT International Application No. PCT/EP2016/062046 filed May 27, 2016 claiming priority to EP 15179157.1 filed Jul. 30, 2015.

### TECHNICAL FIELD

The present invention relates to a thread former comprising a shank and a forming section having a polygonal cross-section, one or more ridges of the thread former extending along the circumference of the forming section such that the forming section includes at least two axially adjacent ridges or ridge portions, respectively each having at least one interruption.

### BACKGROUND

Thread formers or forming taps of the aforementioned type have long been known. The shank of such a thread former defines an axis and has a generally cylindrical shape or a corresponding clamping end, and a forming section adjoining the shank and oriented along the axis of the shank. This forming section has a polygonal cross-section, the term “polygonal cross-section” designating a projection of the forming section to a plane perpendicular to the axis of the shank and the forming section, and the corners of a corresponding polygon being typically rounded. The polygonal cross-section is ultimately defined by the radially outer crests of the (s) of the forming section, wherein the radius of this crest of the ridge(s) is continuously varying along a circumferential path about the axis, i. e. the radially most outwardly protruding crest of a ridge changes its radial extension along the circumferential path alternately between maxima and minima, the maxima defining the polygon corners and the minima forming the radially most retreated regions, respectively, of the polygonal periphery.

Corresponding thread formers or forming taps typically have a triangular, quadrangular or five-cornered cross-section, but the cross-section may in principle also have more or fewer corners. The polygonal cross-section, which is illustrated by way of example for an embodiment in FIG. 8, is indicated only by way of illustration and without limitation. For example, the ridge(s) extends along a screw line around the axis of the forming section. Two or more parallel, helically circumferential ridges can also be provided for multi-pass threads. However, the ridges can also be annularly extending ridges or ribs arranged in a plane perpendicular to the axis, when the thread former is moved in the manner of a thread milling cutter along a screw line axially and along the inner wall of a hole whose inner radius is greater than the maximum outer radius of the forming section.

### SUMMARY

The present invention relates to all of the aforementioned types of thread formers, depending on the material of a workpiece and the diameter of the tapped hole, whether and which type of thread former can be used for the particular case. For the realization of the present invention, it is only important that at least two axially adjacent ridge sections are present which each have an interruption. As a rule, such a thread former has either one or more continuously circumferential ridges with at least 5 to 10 complete turns, or a corresponding number of parallel, annular ridges is provided. The axially adjacent sections of a single peripheral ridge are also referred to here as axially adjacent “ridges”, as long as it is not important whether a single ridge is continuously provided in a helical manner or whether a plurality of parallel helically circumferential ridges or parallel annular ridges extending in a plane are provided.

Such thread formers produce internal threads in holes by means of plastic deformation of the material of the inner wall of the hole or bore. The inner threads produced in this way have an inner radius which corresponds at least to the radius of the base of the grooves between the ridges of the thread former, and wherein the outer radius (resp. nominal radius) of the inner thread corresponds to the maximum outer radius of the ridges of the forming section. The maximum radius of the ridges and grooves may increase in the axial direction from the front end of the thread former to the shank to better distribute the required deformation work on the ridge portions axially along the forming section.

In the plastic deformation of the material into which a corresponding thread is formed and depending on the speed with which the thread forming takes place, inter alia also heat (also by friction) is generated to a considerable extent, the heating of the forming section accelerating or effecting wear.

To prevent the wear of the forming section, i. e. particularly of the ridge portions in the polygonal corner regions, forming sections of some prior art thread formers have already cooling and lubricating grooves extending axially across the forming section and typically angularly spaced from the corners of the polygonal cross-section. These cooling/lubricant grooves effectively form interruptions of the lands or ridge portions of the forming section.

The fluid supplied via the lubricant grooves reduces the friction between the ridges of the forming section and the material of the workpiece and at the same time causes cooling. As a result, the wear can be considerably reduced with the same machining time per tapped hole, or the machining speed can be considerably increased without a significant increase in wear. In view of the above prior art, it is the object of the present invention to provide a thread former of the type mentioned at the outset, in which the wear is further reduced and the machining speed or the number of manufactured tapped holes can be further increased without increasing the wear or even with the reduction of the wear.

This object is achieved by arranging at least a part of the interruptions on axially adjacent ridge sections at different angular positions.

In other words, the interruptions do not form an axially continuous groove, but are arranged offset in the circumferential direction on axially adjacent ridge sections so that coolant and lubricant supplied via the shank and the interruptions is guided along a zigzag path through the interruptions and along groove sections between the forming ridges to an axially adjacent interruption, which due to the offset of the interruptions causes at least a part of the coolant to be forcedly passed over the corner portions of the polygonal cross-section which provide the major part of the deformation work and which are thus cooled and lubricated better, and the wear can be significantly reduced and a considerably larger number of threads can be formed before a wear occurs, as would be the case with a smaller number of threads produced with conventional thread formers.

In any case, corresponding interruptions offset in the circumferential direction with respect to one another should be provided in at least a part of adjacent ridges, so that the coolant and lubricant which is supplied via the interruptions must flow between two interruptions along the circumferential direction of a groove between the ridge sections, Thereby, the most stressed corner portion of the forming section is in particular effectively cooled and lubricated.

Particularly effective is this forcing of the coolant over a zigzag path across the radially protruding forming cams in the manufacture of threads in base holes when the supply of the coolant takes place axially through the shank and the forming section to one or more front face openings at the front end of the thread former. Since the coolant cannot escape from the base hole in any other way and is under pressure, it must necessarily take the path between the outside of the thread former and the partially or entirely shaped internal thread in the base hole, the sequence of interruptions determining the flow path through the forming cams of the thread former and thus particularly effectively cools and lubricates the same.

In the production of threads in through-bores, the efficiency of the cooling and lubrication can also be optimized by an axial supply of the coolant via the shank and the forming section by the fact that the outlet opening(s) for the coolant do not open at the end face but are located radially in the forming section. For the location of the outlet openings, one or more of the interruptions may be used, which can then be connected via one or more radial bores to the axial feed channel or Supply channels for the coolant. If one or more of the radial outlet openings for the coolant are provided, in particular, in the vicinity of the front end of the forming section, such a variant can provide a very effective cooling and lubrication in the production of threads in both, base holes and through-holes.

In a preferred embodiment of the invention it is provided that the angular positions of interruptions are located at an angular distance of less than 40°, and preferably at an angular distance of less than 25°, for example at 20° or 15°, from the corner regions of the polygonal cross-section.

In one embodiment of the invention, the bottom for the interruptions should lie on a radius of the forming section, which corresponds to the radius at the bottom of a ridge in the middle between adjacent corner areas of the polygonal cross-section. However, the recesses may also be somewhat deeper if necessary in order to provide in any case an axial passage for coolant between two adjacent grooves of the forming section.

The proximity of the interruptions to the polygonal corner regions ensures that the coolant and lubricant rapidly reaches the most stressed corner portions of the forming section from the interruptions.

On the other hand, the interruptions must also be provided at a sufficient distance from the corner regions since the ridges provide the strongest deformation work, especially in the corner regions, and form the base and the final profile of the inner thread to be formed.

In a planar view along a radius on the forming section, according to an embodiment of the invention, the interruptions are approximately circular.

In one embodiment of the invention, the maximum diameter of an interruption may be located between approximately half the axial distance and the two-fold axial distance between axially adjacent ridge sections. The recess can therefore directly connect the base of the grooves on the side of a ridge at the same radial height, while the bottom of the recess also being able to lie somewhat deeper (on a smaller radius with respect to the axis of the thread former) than the bottom of the grooves connected by the interruption.

According to an embodiment of the invention, the interruptions are arranged in the axial direction on each second ridge at the same angular position, but variations of this arrangement are also conceivable, so that the angular position of interruptions is repeated, if appropriate, only on every third or fourth ridge.

According to another embodiment, at most one interruption is provided per 360° circumferential section of a ridge (but at a different angular position than the preceding interruption). For example, the interruptions along a helically circumferential ridge could each be offset by 432° from the next or the preceding interruption. This forces the coolant and lubricant as it passes through the interruptions to flow along all of the corner regions of the polygonal cross-section, thus forcibly lubricating each corner region.

According to one embodiment, the polygonal cross-section of the forming section has at least three and at most seven, and in particular five, corner areas.

The difference between the smallest radius and the largest radius of the polygonal cross-section has in embodiments of the invention an amount, which is between 0.5 times and 2 times the ridge height (profile depth) in the corner region of the polygonal cross-section.

However, preference is given here to a variant in which the maximum difference in the radii of the crest along a (and preferably along most of the) ridge section covering 360° is in all cases smaller than the profile depth in the corner areas of the polygonal cross-section. This effectively limits any parallel flow of cooling and lubricant axially along the angular positions of the smallest radius of the crest points.

Further advantages, features and possible applications of the present invention will become apparent from the following description of a preferred embodiment and the accompanying figures.

### BRIEF DESCRIPTION OF THE DRAWINGS

FIGS. 1a-d show different views of the forming section of a thread former according to an embodiment of the present invention.

FIGS. 2a-d: show various views of a prior art thread former without interruptions of the ridges.

FIGS. 3a-d show different prior art views of interruptions of the ridges, which are arranged on adjacent ridges or adjacent turns of a ridge in a row axial behind one another.

FIGS. 4a-d show different views of a second embodiment according to the present invention.

FIGS. 5a-d show various views of a third embodiment of the present invention.

FIGS. 6a-d show various views of a fourth embodiment of the present invention.

FIGS. 7a-d an overview over four different embodiments of the present invention.

FIG. 8 shows the profile of the forming section of an embodiment of the present invention.

FIGS. 9A-9E: are wear test photos of prior art tools (9A-9C) and of tools in accordance with the present invention (9D and 9E).

### DETAILED DESCRIPTION

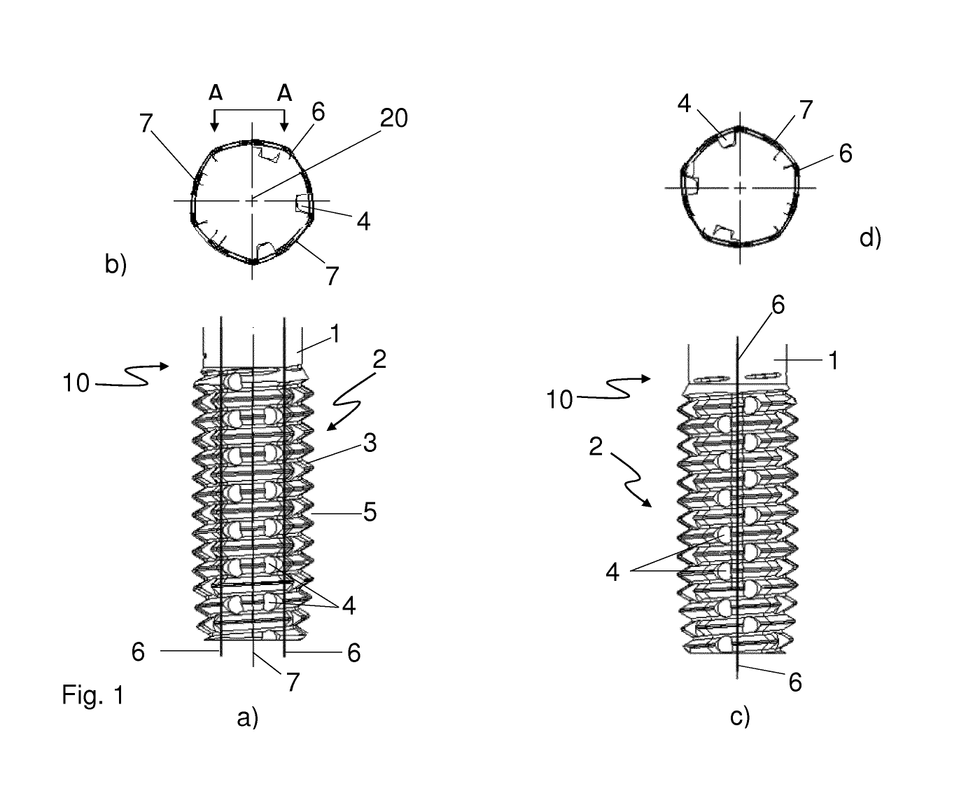

FIGS. 1a-d shows different views of a first embodiment of the present invention, wherein FIGS. 1a and 1c show side views from different viewing angles and FIGS. 1b and 1d show respective end-face views corresponding to a view of FIGS. 1a and 1b, respectively, from below. FIGS. 1a and 1c respectively correspond to views of the forming sections 2 in FIGS. 1c and 1d respectively from above. This applies analogously to all side views and end-face views in FIGS. 1 to 6.

FIG. 1 shows the essential part of a forming tap or thread former 10 with a section of the shank 1 and a forming section 2 axially adjoining the shank 1, which alternatively could have a plurality of parallel, annularly extending ridges, but here has a screw-shaped circumferentially extending ridge 3. By means of the illustrated embodiment, an internal thread can be produced in a corresponding bore.

In FIG. 1a, corresponding to the top view of FIG. 1b from above, there is located in the center of FIG. 1a a radially most retracted position of the pentagonal cross-section marked by a vertical line 7. FIG. 1c shows the same thread former, however, a corner region, which is likewise marked by a vertical line 6, is located in the center of the figure. It may be seen by comparison of FIGS. 1a and 1c that the recesses 4 are located slightly closer to the corner regions 6 than to the retracted positions 7, which are located in the middle between adjacent corners or corner regions 6.

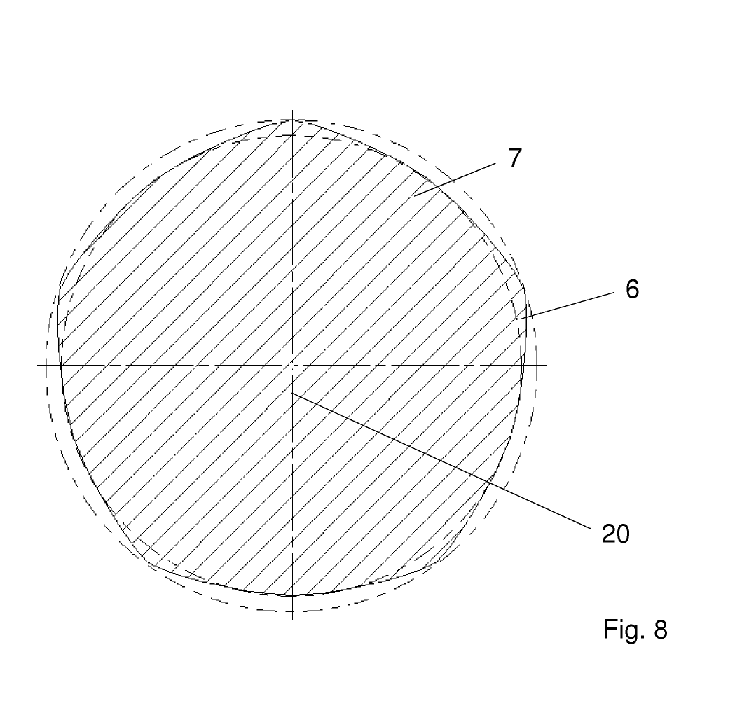

Further, the first three ridges 3 at the lower or front ends of the forming section 2 have a smaller radius with respect to the central axis 20 increasing from the bottom to the top in order to distribute the load upon tapping more uniformly along the length of the forming section. In an axial projection of the forming section 2 according to FIG. 8, it can be seen that the projection of the crest line of the ridge on a plane perpendicular to the axis 20 of the tool defines a regular pentagon with rounded corners 6 and radially most retracted sections 7. Dashed lines indicate the minimum and the maximum distance of the forming ridge 3 from the axis 20. The inner radius of the inner thread to be produced can be smaller than the radius of the circle inscribed in the profile in FIG. 8, while the outer circle covering the profile substantially corresponds to about the nominal diameter of the internal thread or is slightly larger. Along the circumference of the forming section 2 there are five corner positions at angular distances of 72° each, which define the position of the five corners 6, and five retracted positions 7, which respectively represent the centers of the pentagon side edges.

It is understood that the pentagonal profile shown is only an example and corresponding thread formers could also have an elliptical (rounded “two cornered”), a triangular or else polygonal (n-cornered with n, for example, between 4 and 10) profile which profile must not be necessarily axially symmetrical, even if the latter is preferred. Axial symmetry in this context means that the contour of the forming section after rotation by a fixed angle, which has the value 360°/n, when n is the number of corners 6 of the profile, remains the same in the top-face plan view (corresponding, for example, to FIGS. 1b and 1d).

In FIG. 1a the position of two corners 6 is represented by vertical black lines. In the case of FIG. 1, the forming ridge 3 is a single, continuous thread ridge, wherein the radially most protruding corner regions 6 are provided at the same angular positions over the axial length of the forming section 2.

In the embodiment according to FIG. 1, an interruption 4 is arranged alternately on the right and left of the corner 6 on each ridge turn or on the axially juxtaposed ridge sections 3, wherein the interruptions on axially adjacent sections of the ridge opposite the corner 6 are alternately in front of or behind of the corner in the circumferential direction. In the present exemplary embodiment, the ridge has a recess 4, preceding the corner in the direction of rotation by, for example, 15°, while the corresponding recess 4 on the next ridge turn or the adjacent ridge section lags the corner by approximately 15°.

The supply of a lubricant takes place axially via a central bore (not shown) in the shank 1 and in the forming section 2, wherein the present tap is provided for blind boreholes and the coolant and lubricant impinges on the bottom of the blind hole bore and flows back via the outer side of the forming section 2, and via thus the recesses 4 and grooves 5, thereby also lubricating and cooling the corner regions 6 of the forming section 2.

In the case of through-holes, the lubricant could instead be sprayed from the outside onto the forming section 2 and/or the shank 1. Alternatively, in the case of through-bores, an internal coolant feed can also be used in which, however, the supply bore extending axially through the shank 1 and extending into the forming section 2 does not open at the front end but as above already described, via at least one further radial bore in the forming section, preferably in the region of one or more interruptions, in particular on the front ridges in the vicinity of the front end of the forming section and, if appropriate, distributed also over the length of the forming section. In a borehole in which the thread is produced, the ridges 3 or the individual windings or sections of this ridge 3 prevent bypassing of the corners 6 by a direct axial flow of a coolant and/or lubricant. The coolant/lubricant supplied either axially from the inside of the shank 1 and the forming section 2 or externally from the outside will flow within the thread bore preferably through the corresponding recesses 4 in the axial direction and then must flow over the corner 6 along a thread groove and may only then continue to flow on the other side of the corner 6 through the next recess 4 along the axial direction. The fluid supplied consequently follows a zigzag path through the recesses 4 and the intermediate grooves between the ridges or ridge turns, and between the recesses in each case via the corner region 6. This leads to a very effective cooling and lubrication of the ridge 3 or individual ridge sections and thus reduces wear on the forming sections 2.

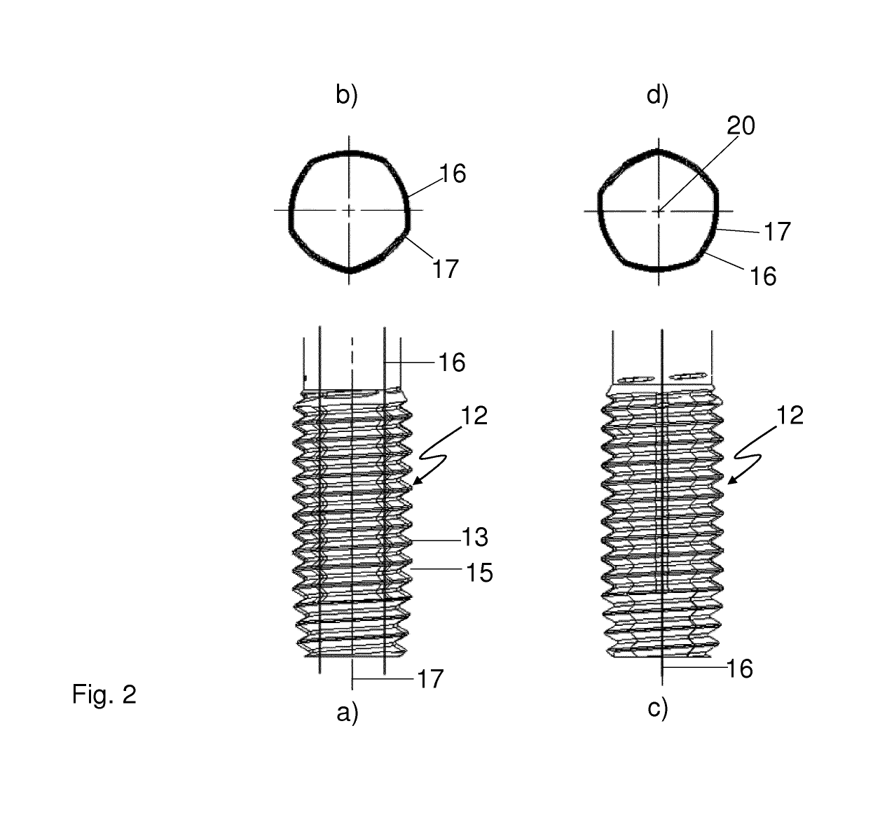

FIGS. 2a-d show, for comparison purposes, a conventional thread former in views analogous to FIGS. 1a-d, the reference numbers used for analogous elements each having a prefixed “1” compared to figure This thread former has a shank 11 and a forming section 12, the apex of the ridges 13 also forming a regular polygon, in particular a pentagon, in an axial projection.

The coolant and lubricant supply from outside is relatively difficult with the use of such a tool, since coolant and lubricant, respectively, which is to reach the front threads must first flow along the circumference of the forming section through the thread grooves 15 between the ridges 13 which are largely blocked by the wall material of the drill hole.

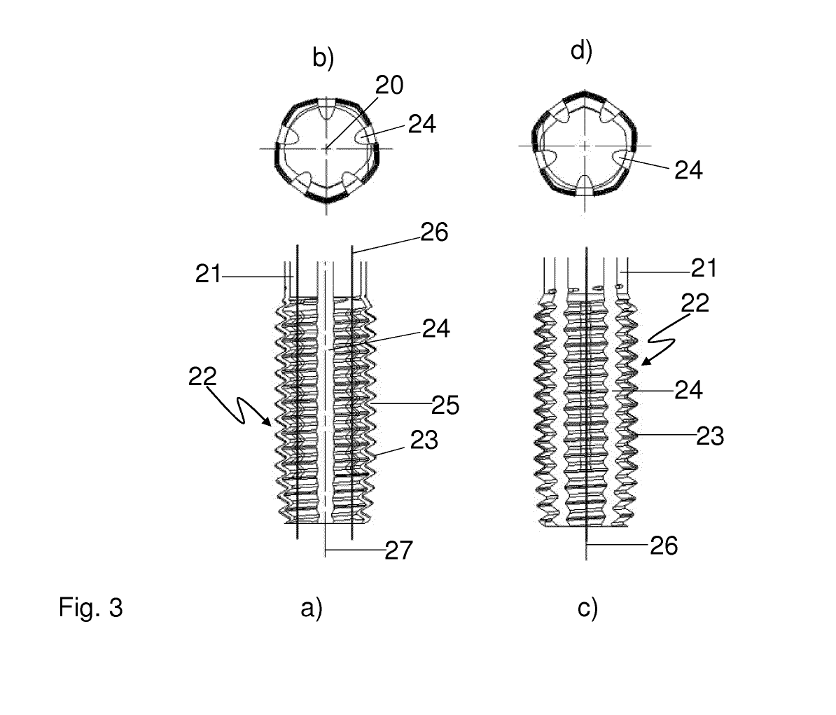

FIGS. 3a-d show different views of a further thread former according to the prior art, the reference numbers used for analogous elements each having a prefixed “2” compared to FIG. 1a-d. This thread former has a shank 21 and a forming section 22, wherein the recesses on the individual ridge turns 23 are in each case arranged axially one behind the other, thus forming axially continuous coolant and lubricant grooves 24. In this prior art, a central supply passage (not shown) is provided in the interior of the shank 1 and of the forming section 2, which opens out on the free end face of the forming section and is used for blind holes for better cooling and lubrication. The coolant must then flow back axially on the outside of the forming section. For this purpose, a so-called relieving or venting groove 24 is provided whose base is still located radially within the base of the thread-forming grooves 25 between the ridges or ridge sections 23, whereby the coolant and lubricant flow very rapidly through the axial grooves 24 and comparatively little thereof can act on the polygonal corner region 26 lying between the grooves 24.

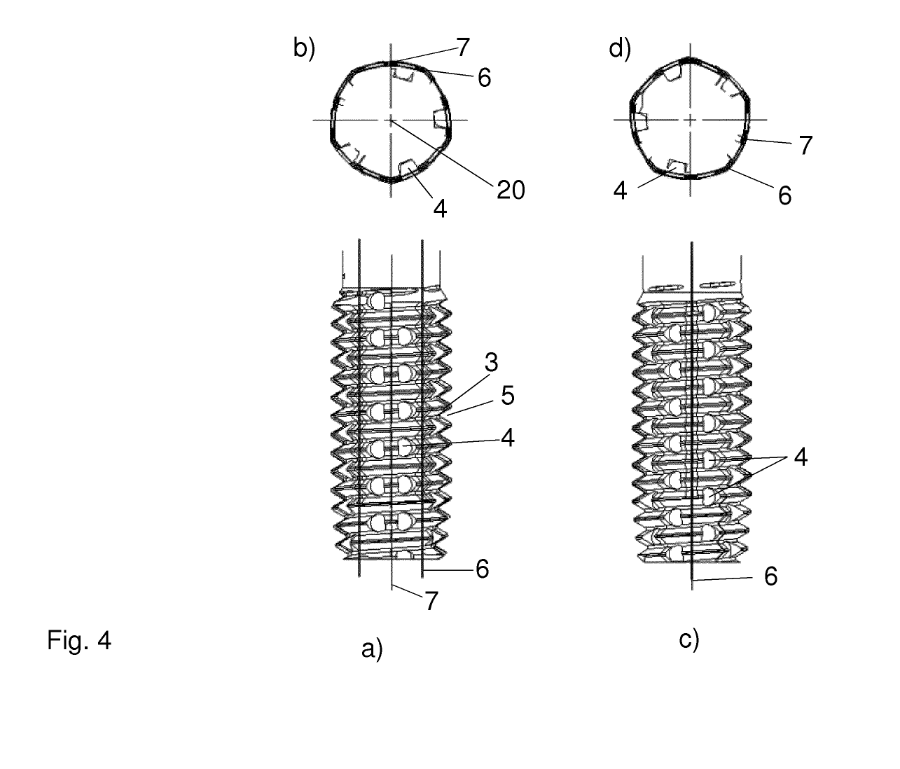

FIGS. 4a-d show different views of a second embodiment of the present invention analogous to the views in FIGS. 1a-d, wherein the second embodiment is very similar to that of FIG. 1 with the only difference being that the angular distance of the recesses 4 to the next polygon corner 6 is about 20.

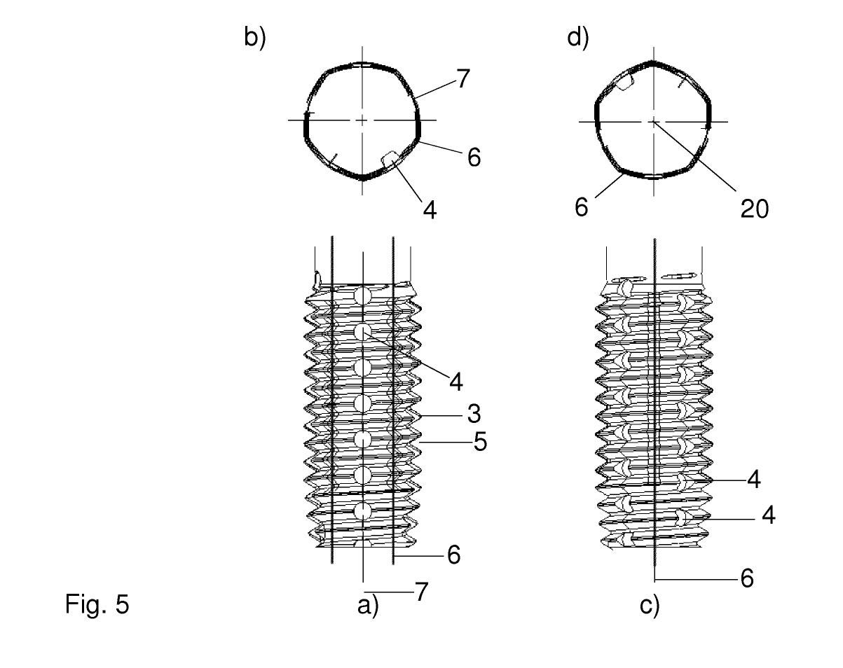

In the case of the third exemplary embodiment according to FIGS. 5a-d, the recesses 4 with respect to the polygon corner 6 lie on each second ridge turn in each case at ±36°, i. e. just at the lowest point 7 of the crest between the two adjacent corners of the underlying polygon. Thus, in all regions 7 in the middle between adjacent corners 6, recesses are provided at the same axial position on each second ridge turn.

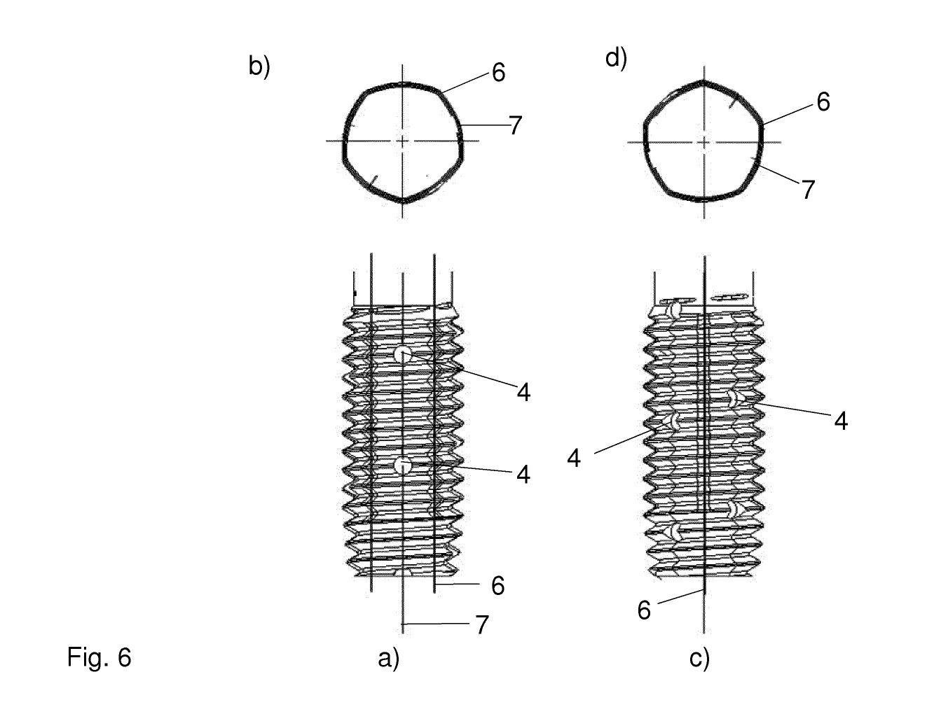

FIG. 6 shows, in turn, views of a fourth embodiment of the present invention wherein the two side views according to FIGS. 6a and 6c are twisted relative to one another with respect to the axis 20 by 36°, as can also be seen in the cross-sectional views of FIGS. 6b and 6d, which are views of FIGS. 6a and 6c from below.

In this case, the next recess behind a recess 4 in the course of the thread (viewed in both directions) is provided only after 432° of thread ridge path, which means an offset by 72° in the side view according to FIGS. 6a and 6c and to the respectively following ridge. The next recess is thus arranged offset by a distance of 72° from a recess 4 in a ridge section 3 near the shank 1 so that the circumferential position for each recess 4 repeatedly occurs after five ridge turns.

This means that a coolant which passes through the forming section from the bottom upward (or also from the top downward) after passing through one of the recesses 4 over a circumferential section of 72°, which also includes a corner area 6, has to flow to the next recess 4 in which it can once again enter axially into the next groove 5 between ridges and in turn has to flow over a peripheral portion of 72° and over a corner region 6 before it reaches the next recess 4.

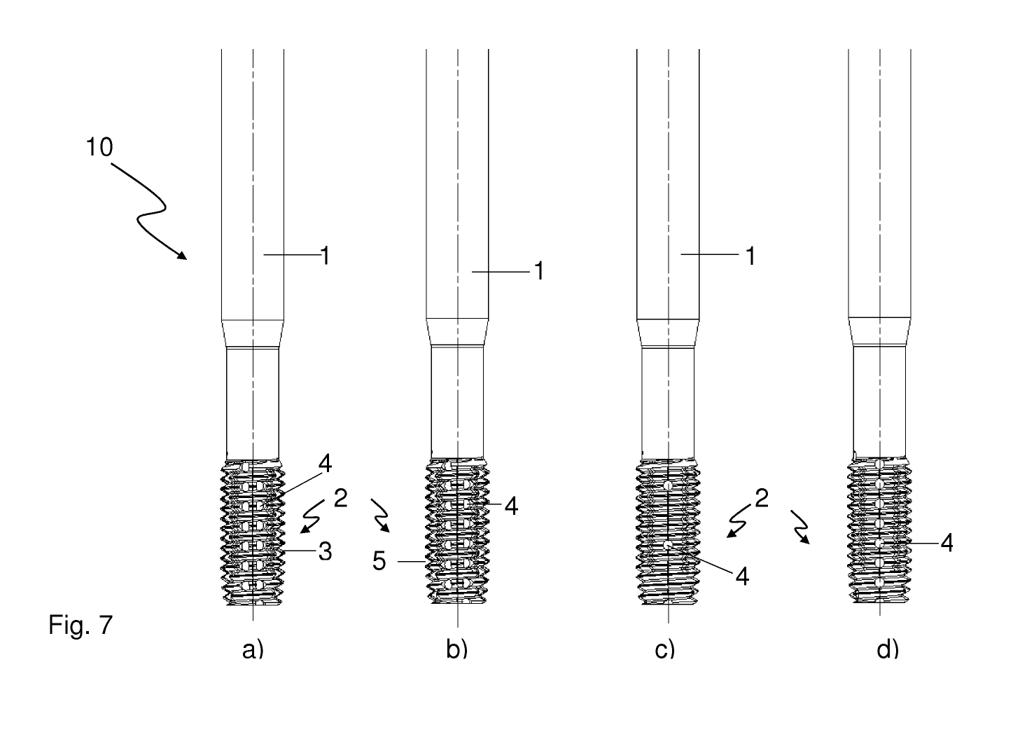

FIGS. 7a-d show once again more complete pictures of the embodiments according to FIGS. 1, 4, 6 and 5 in this sequence, wherein in each case a somewhat larger section of the shank 1 which is not visible in the remaining figures is reproduced.

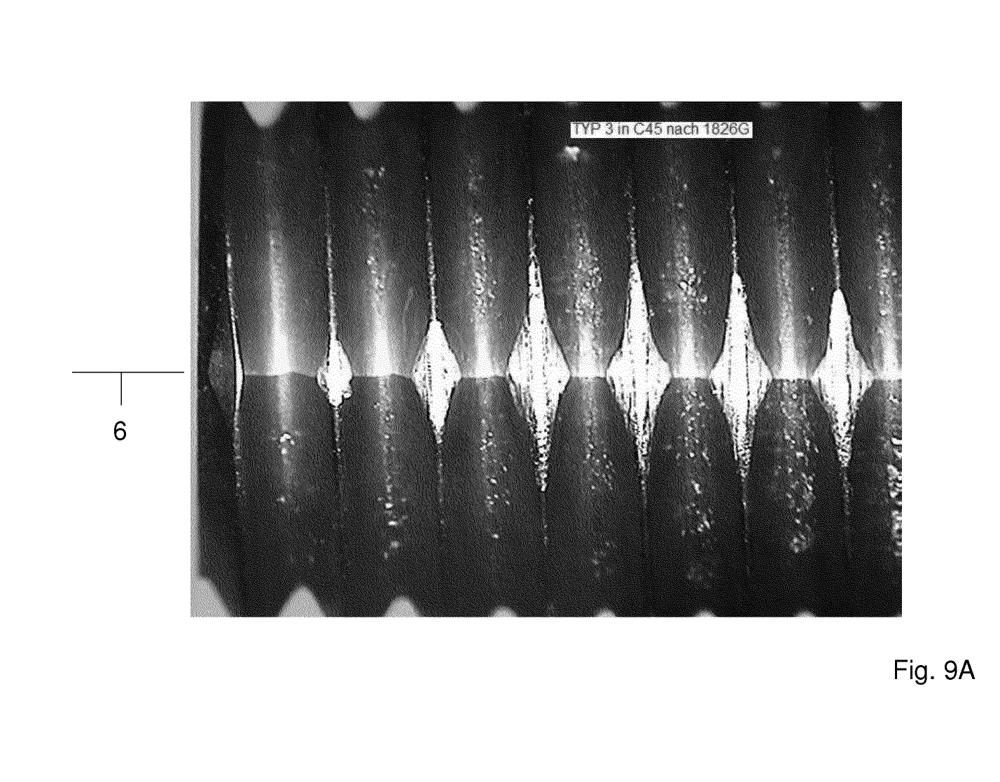

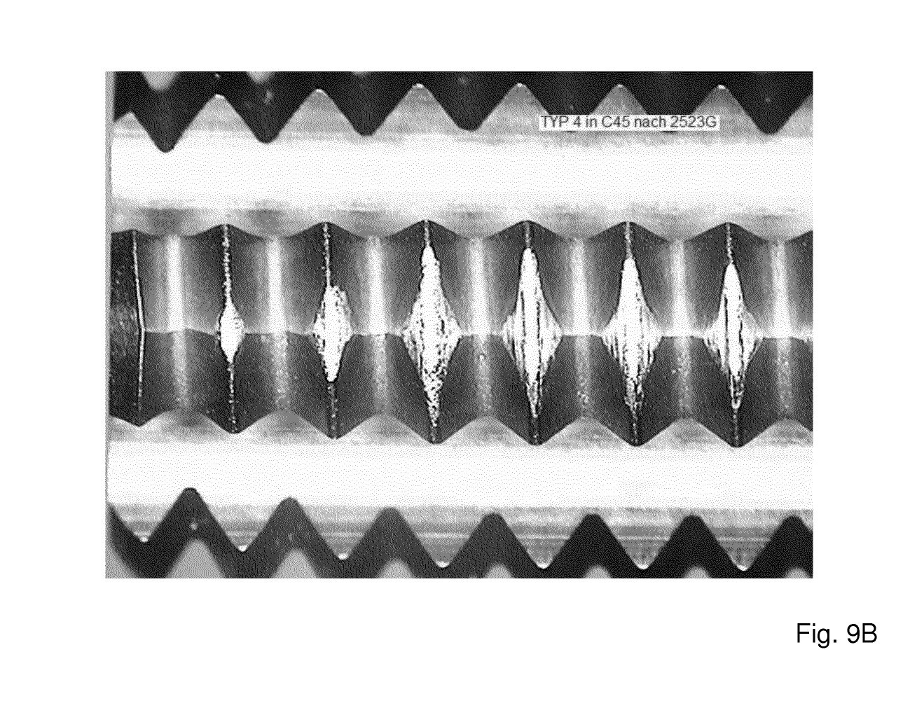

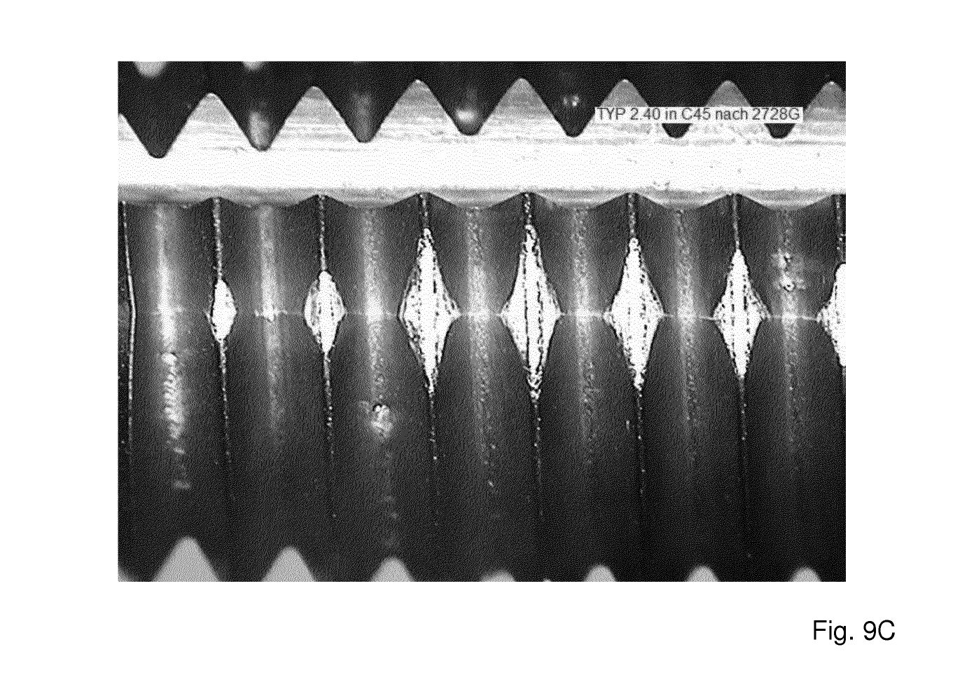

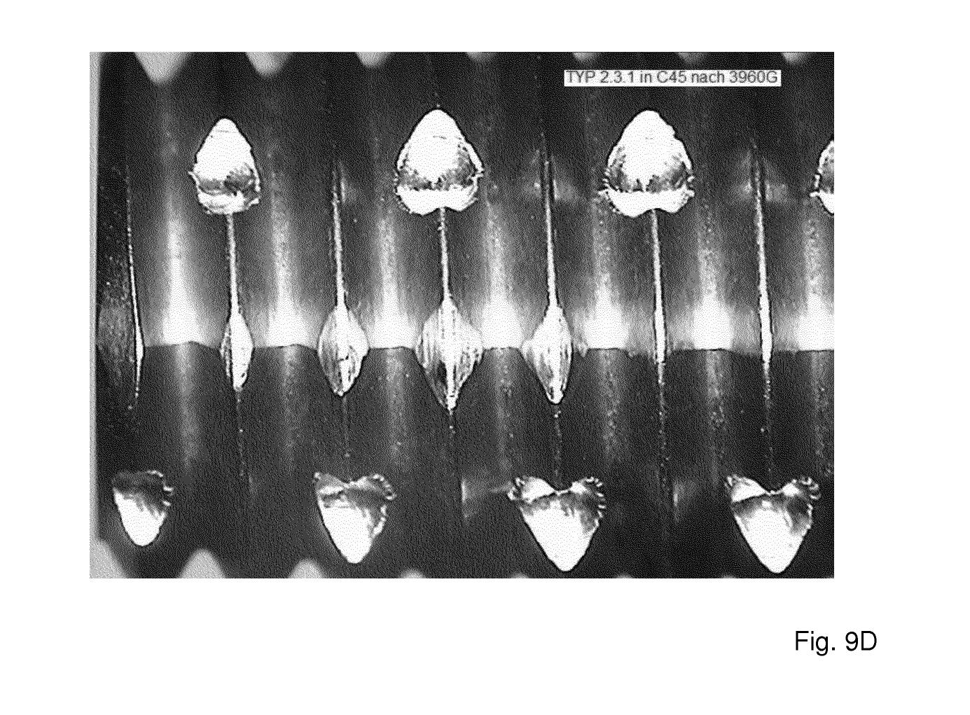

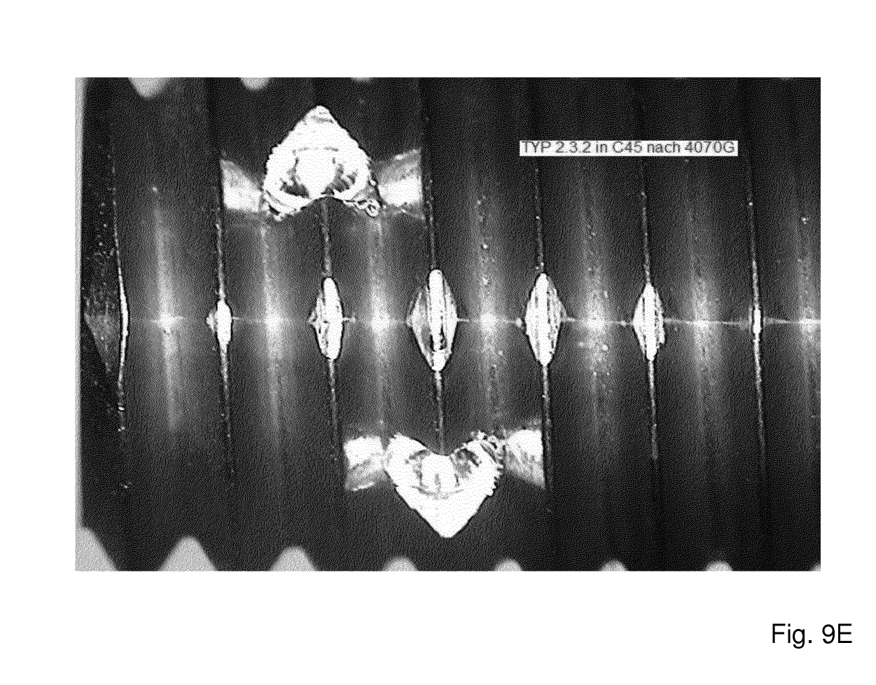

FIGS. 9A-E show the results of comparative tests between three prior art thread formers and two thread formers according to the present invention. All the taps of FIGS. 9A-E were tested under the same conditions and on the same machine. The thread formers were each used for production of a number of threads of the same dimensions and in the same material until the degree of wear shown in FIGS. 9A-E was reached. The number of threads produced up to this degree of wear is shown in Table 1.

FIG. 9A shows the wear of a thread former without lubricant grooves according to FIG. 2, the coolant and lubricant being supplied externally, i. e. was sprayed onto the accessible area of the forming section 2 outside the tapped hole from the outside. The coolant jet was thus directly (e.g. obliquely from the rear) sprayed on the lower portion of the shank 1 and the adjacent forming section 2. The wear occurs primarily at the polygonal corner regions 6, the position of this corner region 6 being additionally marked in FIG. 9A, which also extends along the corresponding central axis 6 of the photographs in all other FIGS. 9B-9E.

FIG. 9B shows the wear in a thread former according to FIG. 3, wherein the coolant and lubricant supply took place in the same manner as described above from the outside. FIG. 9C shows the wear on a tool according to the state of the art similar to the embodiment according to FIG. 3, but with internal coolant lubricant supply, i.e., the lubricant is fed through an axially extending passageway through the entire tool to the front end where it meets the bottom of a blind hole, the cooling lubricant then being guided back over the lubricant groove 24 so that the front section , which is most strongly subjected to the deformation work, is more effectively cooled.

FIGS. 9D and 9E show the wear in the case of two thread formers according to the invention, FIG. 9D showing the results of a thread former according to FIG. 4, in which the interruptions on axially adjacent threads were alternately advanced or offset by 20°, while in the case of the tool according to FIG. 9E, the interruptions were arranged at the deepest point between the polygonal corner regions (corresponding to FIG. 6), respectively, on axially successive ridges, respectively offset by 72° in the same direction or in other words following the course of the ridge path and occurring after 432° so that the pattern of the interruptions or the angular position of the interruptions is repeated after five thread turns (5 axially successive thread ridges).

The test results are summarized in Table 1 below.

| | Coolant/ | Coolant/ | | | |
|---|---|---|---|---|---|
| Thread | lubricant | lubricant | Lubricant | | |
| former | internal | external | groove | Remark | Result |
| A | | X | Without | Prior art | 1862 |
| B | | X | Yes | Prior art | 2523 |
| C | X | | 1 Relief | Prior art | 2728 |
| | | | groove | | |
| D | X | | Interrupted | According to | 3960 |
| | | | | invention | |
| E | X | | Interrupted | According to | 4053 |
| | | | | invention | |

The thread formers A to E of the above table are the tools shown in FIGS. 9A-E. The thread former B had a number of axially extending lubricant grooves 24 corresponding to the number (=5) of the forming cams, the coolant feed occurring from the outside. The thread former C (corresponding to FIG. 3) was provided for the thread manufacture in blind holes and had an internal coolant feed to the tool tip, wherein the (in this case single) groove 24, which is flown through from the front to the rear, is mainly serving for preventing an excessive pressure rise in the blind hole and which is therefore referred to as a “vent groove” or “relief groove”.

The last column of the table shows the number of threads made up to the degree of wear shown in FIGS. 9A-E with the respective thread former.

Because of the internal supply of lubricant, which is likewise provided in the case of the thread formers D and E according to the invention, the thread former C is still most closely comparable to the thread formers D and E according to the present invention.

With respect to the prior art there is show a clear improvement in the service life and the number of threads produced up to a given wear.

Even when compared to the best comparative tool C, an increase of about 45 to 48% is found in the number of threads produced.

For the purposes of the original disclosure, it is to be understood that all features as will become apparent to those skilled in the art from the present description, the drawings, and the dependent claims, although described specifically only in connection with certain further features, both individually and in any combination can be combined with other of the features or feature groups disclosed herein to the extent that this has not been expressly excluded or technical circumstances make such combinations impossible or meaningless. The comprehensive, explicit representation of all conceivable feature combinations and the emphasis on the independence of the individual features from one another is dispensed with here only for the sake of brevity and the legibility of the description.

1. A thread former comprising:
a shank and a forming section having a polygonal cross-section;
a plurality of ridges or ridge sections of the thread former extending along a circumference of the forming section, the forming section having at least two axially adjacent ridges and/or a plurality of interruptions, wherein on axially adjacent ridge sections at least some of the interruptions are arranged at different angular positions.

2. The thread former according to claim 1, wherein the plurality of ridges or ridge sections that include the interruptions extend over more than 3 times 360° of the circumference.

3. The thread former according to claim 1, wherein the interruptions on each of the ridge sections extending over 360° of the circumference are provided at a narrow angular distance adjacent at least one corner of the polygonal cross-section of the forming section in a circumferential direction.

4. The thread former according to claim 1, wherein the angular positions of the interruptions are located at an angular distance of less than 40° from corner regions of the polygonal cross-section.

5. The thread former according to claim 1, wherein a helically extending circumferential ridge or a plurality of parallel helically extending ridges are provided on the forming section.

6. The thread former according to claim 1, wherein the plurality of ridges are annular-shaped ridges provided at uniform axial distances on the forming section.

7. The thread former according to claim 1, wherein a bottom of the interruptions lies on a radius of the forming section, which corresponds to a radius of a ridge in a middle between adjacent corners of the polygonal cross-section.

8. The thread former according to claim 1, wherein the interruptions are approximately circular in a radial plan view of the forming section.

9. The thread former according to claim 1, wherein a maximum diameter of an interruption lies between approximately half and twofold of an axial distance between axially adjacent ridge sections.

10. The thread former according to claim 1, wherein the interruptions are arranged at a same angular position on each second or on each third ridge in an axial direction.

11. The thread former according to claim 1, wherein the interruptions are arranged in an axial direction on each nth ridge at the same angular position, where n is the number of corners of the polygonal cross-section.

12. The thread former according to claim 1, wherein the polygonal cross-section of the forming section has at least 3 to 5 corners.

13. The thread former according to claim 1, wherein a difference between a smallest radius and a largest radius of the polygonal cross section is between 0.5 times and twofold of a ridge height in a corner region of the polygonal cross-section.

14. The thread former according to claim 1, wherein a maximum difference of radii of a ridge crest along a 360° of a ridge section is smaller than a profile depth in corner regions of the polygonal cross-section.

15. The thread former according to claim 1, wherein the thread former has at least one inner coolant bore which extends completely or predominantly axially and which opens out in at least one outlet opening either axially on the front end face of the thread former or radially in a region of the ridges, near a front end of the forming section.

16. The thread formed according to claim 15, wherein the at least one coolant bore that opens radially in the region of the ridges opens into at least one of the interruptions.
